(19) United States
(12) Patent Application Publication
(10) Pub. No.: US 2026/0142443 A1
(43) Pub. Date: May 21, 2026

(54) PROTECTOR AND WIRE HARNESS

(71) Applicants: YAZAKI CORPORATION, Tokyo (JP); TS TECH Co., Ltd., Asaka-shi (JP)

(72) Inventors: Kazuto Uehara, Nasukarasuyama-shi (JP); Yoshitake Aruga, Nasukarasuyama-shi (JP); Ken Ito, Susono-shi (JP); Nobuyuki Tezuka, Shioya-gun (JP); Kazuki Kobayashi, Shioya-gun (JP)

(21) Appl. No.: 19/448,028

(22) Filed: Jan. 13, 2026

Related U.S. Application Data
(63) Continuation of application No. PCT/JP2024/024519, filed on Jul. 8, 2024.

(30) Foreign Application Priority Data
Aug. 8, 2023 (JP) 2023-129508

(51) Int. Cl. H02G 3/04

(52) U.S. Cl. CPC H02G 3/0462

(57) ABSTRACT

A protector includes a tubular part, a covering part, and a support part. The tubular part is formed around an axis in a tubular shape, locked to a headrest stay formed in a tubular shape in a state where the tubular part is inserted into the inside of the headrest stay, and into which a wiring material is inserted. The covering part is provided on one side of the tubular part in an axial direction along the axis, placed outside the headrest stay, and covers a tip end of the headrest stay in the axial direction.

### CROSS-REFERENCE TO RELATED APPLICATION(S)

This application is a continuation application of International Application PCT/JP2024/024519, filed on Jul. 8, 2024 which claims the benefit of priority from Japanese Patent Application No. 2023-129508 filed on Aug. 8, 2023 and designating the U.S., the entire contents of which are incorporated herein by reference.

### BACKGROUND OF THE INVENTION

### 1. Field of the Invention

The present invention relates to a protector and a wire harness.

### 2. Description of the Related Art

Conventionally, Japanese Patent Application Laid-open No. 2008-052 979 discloses a connector unit that includes a metal holder formed in a tubular shape and a connector housed in the holder. In this connector unit, one of the holder and the connector is provided with a protrusion that protrudes to the other, and the other is provided with a protrusion housing hole that fixes the holder and the connector by housing the protrusion. The tip end part of the connector on the side fitted to a counterpart connector is disposed outside the holder than one end part of the holder in the longitudinal direction. Japanese Patent Application Laid-open Nos. 2018-014 4606, 2022-103 997, 2022-189 686, 2018-095 029, 2008-030 654, H9-086 250, 2006-341 699, 2008-049 820 and 2016-165 968 disclose protectors and wire harnesses related to the technology of routing a wiring material in a pipe member.

Incidentally, for example, the connector unit disclosed in the Patent Literature 1 described above electrically couples the headrest side and the seat back side, by fitting the connector coupled to the wiring material that is routed in the headrest stay serving as a holder (pipe member), to the counterpart connector provided in the seat back. Because the wiring material is routed in the headrest stay via such a connector coupling, the number of components may increase.

### SUMMARY OF THE INVENTION

Accordingly, the present invention has been made in view of the above, and an object of the present invention is to provide a protector and a wire harness that can properly route a wiring material in a pipe member.

### Solution to Problem

To resolve the aforementioned problem and achieve the object, a protector according to one aspect of the present invention includes a tubular part formed around an axis in a tubular shape, locked to a pipe member formed in a tubular shape in a state where the tubular part is inserted into an inside of the pipe member, and into which a wiring material is inserted; a covering part provided on one side of the tubular part in an axial direction along the axis, placed outside the pipe member, and that covers a tip end of the pipe member in the axial direction; and a support part provided on another side of the tubular part in the axial direction, that extends to a side opposite to the covering part along the axial direction from the other side of the tubular part, and around which a tape member is wrapped with the wiring material in a state where the support part is supporting the wiring material.

A wire harness, according to another aspect of the present invention includes a wiring material having conductivity; a tape member that fixes the wiring material; and a protector that includes a tubular part formed around an axis in a tubular shape, locked to a pipe member formed in a tubular shape in a state where the tubular part is inserted into an inside of the pipe member, and into which a wiring material is inserted, a covering part provided on one side of the tubular part in an axial direction along the axis, placed outside the pipe member, and that covers a tip end of the pipe member in the axial direction, and a support part provided on another side of the tubular part in the axial direction, that extends to a side opposite to the covering part along the axial direction from the other side of the tubular part, and around which the tape member is wrapped with the wiring material in a state where the support part is supporting the wiring material.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a sectional view illustrating a configuration example of a wire harness according to an embodiment;

FIG. 2 is a perspective view illustrating a configuration example of a protector according to the embodiment;

FIG. 3 is a schematic view illustrating a configuration example of a protector according to a comparative example; and

FIG. 4 is a schematic view illustrating a configuration example of the protector according to the embodiment.

### DETAILED DESCRIPTION OF THE PREFERRED EMBODIMENTS

A mode (embodiment) for carrying out the present invention will be described in detail with reference to the drawings. The present invention is not limited to the contents described in the following embodiment. Moreover, the components described below include those that can be easily assumed by those skilled in the art, and those that are substantially the same. Furthermore, the configurations described below can be appropriately combined. Still furthermore, various omissions, substitutions, or changes in the configurations can be made without departing from the gist of the present invention.

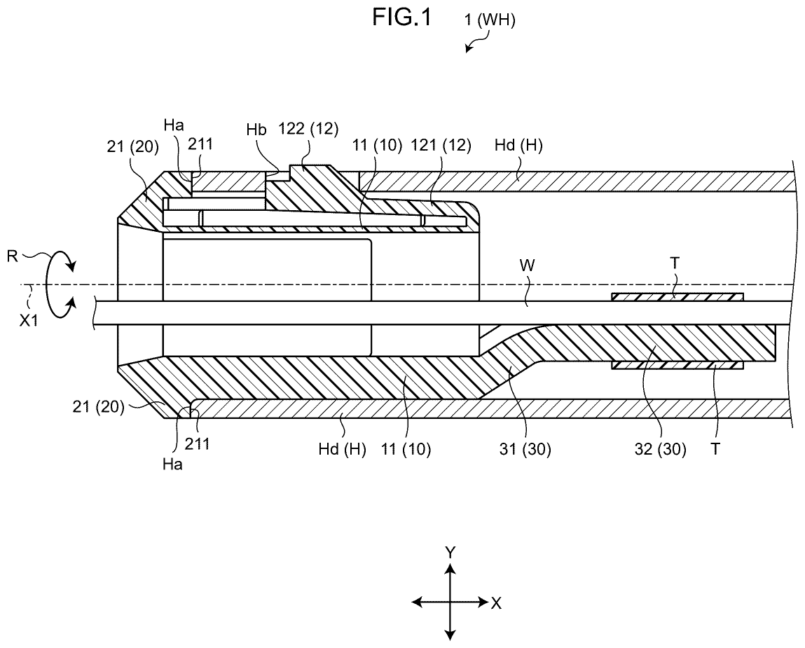

A wire harness WH including a protector 1 according to an embodiment will be described with reference to the drawings. As illustrated in FIG. 1, the wire harness WH includes a wiring material W having conductivity, the protector 1 that supports the wiring material W, and a tape member T that fixes the wiring material W to the protector 1. In addition, the wire harness WH may further include components such as a connector.

For example, the wiring material W is formed of an electric wire, an electric wire bundle, and the like. The electric wire is obtained by covering the outside of a conductor part (core wire) made of a plurality of metal strands having conductivity, with a coating part having an insulation property. The electric wire bundle is a bundle of the electric wires. In the wire harness WH, a plurality of wiring materials W are bundled and aggregated, and various devices are electrically coupled via a connector or the like provided on the terminal of the bundled wiring materials W.

For example, the wiring material W according to the present embodiment is coupled to a device such as a speaker built into the headrest of a vehicle seat. In this example, the vehicle seat includes a seat cushion, a seat back, and a headrest. The seat cushion is a seating part on which the occupant is seated. The seat back is connected to the rear end part of the seat cushion in a rotatable manner, and supports the back of the occupant. The headrest is connected to the upper end part of the seat back in a vertically movable manner, and supports the head of the occupant. The headrest includes a headrest stay H and a headrest pad.

For example, the headrest stay H is a metal pipe member formed in a tubular shape that is bent into an inverted U-shape. For example, the headrest stay H includes a pair of leg parts Hd inserted into a holder provided on the upper end part of the seat back, and a connection part that connects the upper end parts of the pair of leg parts Hd. The headrest stay H connects the headrest pad to the seat back in a vertically movable manner, in a state where the pair of leg parts Hd are inserted into the holder of the seat back. For example, the headrest pad is made of foamed resin, provided on the connection part at the upper end part of the headrest stay H, and supports the head of the occupant. For example, when the wiring material W is coupled to a device such as a speaker built into the headrest, the wiring material W is inserted into the inside of the headrest stay H, and is routed from the seat back side to the headrest side.

The protector 1 holds the wiring material W, in a state where the protector 1 is fitted to a tip end Ha of the leg part Hd of the headrest stay H. In this example, the shape of the tip end Ha of the leg part Hd of the headrest stay H is regulated, to protect the occupant (regulations for interior fittings). For example, to satisfy the regulations for interior fittings, the tip end Ha of the leg part Hd of a conventional headrest stay is formed in a convex spherical shape, by a swaging process. In contrast, the headrest stay H of the present embodiment satisfies the regulations for interior fittings, by fitting the protector 1 to the tip end Ha of the leg part Hd, without forming the tip end Ha of the leg part Hd in a convex spherical shape. Consequently, because the tip end Ha is not formed in a convex spherical shape, the headrest stay H of the present embodiment can prevent the opening part at the tip end Ha from becoming small. Hence, it is possible to easily insert the wiring material W into the tip end Ha, and prevent the workability from deteriorating.

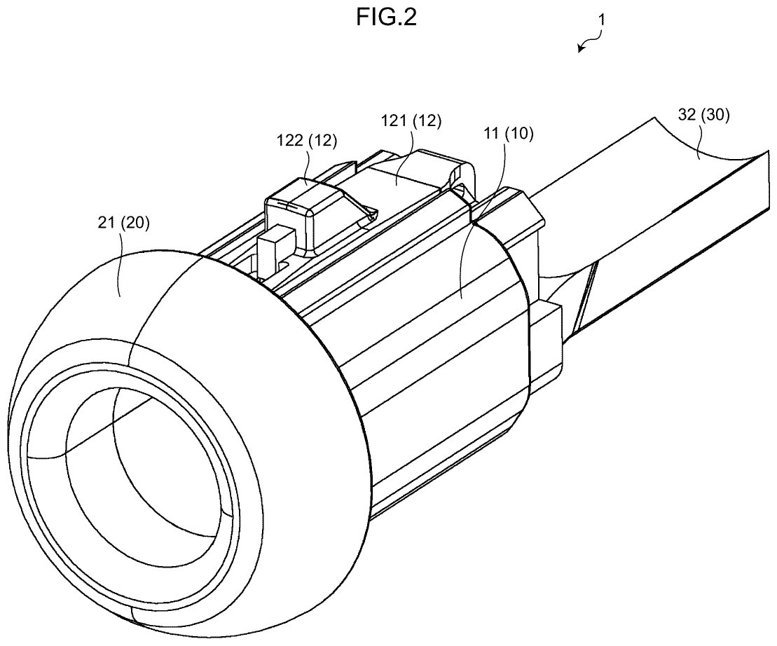

As illustrated in FIG. 1 and FIG. 2, the protector 1 includes a tubular part 10, a covering part 20, and a support part 30. The protector 1 is formed of a resin material having an insulation property or the like, and for example, the tubular part 10, the covering part 20, and the support part 30 are integrally formed, by injection molding a resin material.

The tubular part 10 is a member inserted into the inside of the leg part Hd of the tubular headrest stay H, and includes a tubular part main body 11 and a locking part 12.

The tubular part main body 11 is formed around an axis X1 in a tubular shape, and extends in an axial direction X along the axis X1. When viewed from the axial direction X, the outer shape of the tubular part main body 11 is formed slightly smaller than the internal shape of the leg part Hd of the headrest stay H. Consequently, the tubular part main body 11 can be inserted into the inside of the leg part Hd of the headrest stay H.

The locking part 12 is provided on the tubular part main body 11, and locks the tubular part main body 11 to the inside of the leg part Hd of the headrest stay H. The locking part 12 includes an arm 121 and a locking claw 122.

The arm 121 extends in the axial direction X, and one end of the arm 121 is connected to the outer surface of the tubular part main body 11, and the other end of the arm 121 is a free end. The arm 121 is formed in an elastically deformable manner along a radial direction Y orthogonal to the axial direction X. When the tubular part main body 11 is inserted into the inside of the leg part Hd of the headrest stay H, the arm 121 is pressed by the inner surface of the leg part Hd, and is elastically deformed toward the inside (the axis X1 side) of the tubular part main body 11.

The locking claw 122 locks the tubular part main body 11 to the leg part Hd of the headrest stay H. The locking claw 122 is provided on the free end of the arm 121, and is locked to an opening part Hb provided on the leg part Hd of the headrest stay H.

In the tubular part 10 formed as described above, when the tubular part main body 11 is inserted into the inside of the leg part Hd of the headrest stay H, the arm 121 is first elastically deformed. When the tubular part main body 11 is further pressed into the depth of the leg part Hd, the locking claw 122 is locked to the opening part Hb of the leg part Hd, and the elastically deformed arm 121 returns to the original position. Consequently, in the tubular part 10, the tubular part main body 11 can be locked to the inside of the leg part Hd of the headrest stay H with the locking part 12. In a state where the tubular part 10 is inserted into the inside of the headrest stay H and is being locked, the wiring material W is inserted into the inside of the tubular part 10.

The covering part 20 covers the tip end Ha of the headrest stay H. The covering part 20 is provided on one side of the tubular part 10 in the axial direction X, and includes an annular ring part 21. As illustrated in FIG. 1 and FIG. 2, the annular ring part 21 is formed in a substantially annular ring shape around the axis X1 along a peripheral direction R. When viewed from the axial direction X, the size of the outer shape of the annular ring part 21 is formed equal to that of the outer shape of the leg part Hd of the headrest stay H. In other words, the annular ring part 21 protrudes from the outer peripheral surface of the tubular part main body 11 along the radial direction Y. Consequently, when the tubular part 10 is inserted into the inside of the leg part Hd of the headrest stay H, the annular ring part 21 is placed outside the headrest stay H, in a state where an abutting surface 211 of the annular ring part 21 is abutted to the tip end Ha of the leg part Hd of the headrest stay H. Consequently, the covering part 20 can cover the tip end Ha of the leg part Hd of the headrest stay H in the axial direction X with the annular ring part 21. Hence, it is possible to satisfy the regulations for interior fittings described above.

The support part 30 supports the wiring material W. The support part 30 is provided on the other side of the tubular part 10 in the axial direction X, and includes a connection part 31 and a support plate 32.

The connection part 31 connects the support plate 32 to the tubular part main body 11. The connection part 31 is formed in a plate shape, and connects the end part of the tubular part main body 11 on the side opposite to the covering part 20 in the axial direction X, and the end part of the support plate 32. For example, the connection part 31 connects the end part of the tubular part main body 11 and the end part of the support plate 32, in a state where the support plate 32 is offset from the tubular part main body 11 side to the axis X1 side of the tubular part 10 along the radial direction Y. In other words, in a state where the support plate 32 is separated from the tubular part main body 11 to the axis X1 side, the connection part 31 connects the end part of the tubular part main body 11 and the end part of the support plate 32.

The support plate 32 supports the wiring material W. The support plate 32 is formed in a plate shape, and extends to the side opposite to the covering part 20 along the axial direction X from the other side of the tubular part 10 (side opposite to the covering part 20). In the support plate 32, one end of the support plate 32 in the axial direction X is connected to the end part of the tubular part main body 11 in the axial direction X via the connection part 31. For example, the support plate 32 is connected to the tubular part main body 11, in a state where the support plate 32 is offset from the tubular part main body 11 side to the axis X1 side of the tubular part 10 along the radial direction Y. In other words, the support plate 32 is connected to the tubular part main body 11 in a state where the support plate 32 is separated from the tubular part main body 11 to the axis X1 side along the radial direction Y. The support plate 32 supports the wiring material W inserted into the inside of the leg part Hd, in a state where the tubular part main body 11 is inserted into the inside of the leg part Hd of the headrest stay H. Then, the tape member T is wrapped around the support plate 32 with the wiring material W in a state where the support plate 32 is supporting the wiring material W. Consequently, the support plate 32 can hold the wiring material W in a state where the wiring material W is brought close to the axis X1 side.

The tape member T fixes the wiring material W supported by the support plate 32 to the support plate 32. The tape member T is formed in a belt shape, wrapped around the wiring material W and the support plate 32 in a state where the support plate 32 is supporting the wiring material W, and fixes the wiring material W to the support plate 32.

As described above, the protector 1 according to the embodiment includes the tubular part 10, the covering part 20, and the support part 30. The tubular part 10 is formed around the axis X1 in a tubular shape, locked to the headrest stay H in a state where the tubular part 10 is inserted into the inside of the tubular headrest stay H, and into which the wiring material W is inserted. The covering part 20 is provided on one side of the tubular part 10 in the axial direction X along the axis X1, placed outside the headrest stay H, and covers the tip end Ha of the headrest stay H in the axial direction X. The support part 30 is provided on the other side of the tubular part 10 in the axial direction X, extends to the side opposite to the covering part 20 along the axial direction X from the other side of the tubular part 10, and around which the tape member T is wrapped with the wiring material W in a state where the support part 30 is supporting the wiring material W.

With this configuration, the protector 1 can prevent the tip end Ha of the headrest stay H from being exposed by the covering part 20. Moreover, the protector 1 can fix the wiring material W to the support part 30, by wrapping the tape member T around the support part 30 and the wiring material W, in a state where the support part 30 is supporting the wiring material W inserted inside. For example, compared to a conventional example in which the headrest side and the seat side are electrically coupled, by fitting the connector coupled to the wiring material W routed in the headrest stay H, to the counterpart connector provided in the seat back, the protector 1 can prevent the number of components from increasing. As a result, the protector 1 can properly route the wiring material W in the headrest stay H.

In the protector 1 described above, the support part 30 includes the plate-shaped support plate 32 that supports the wiring material W. The support plate 32 is offset from the tubular part main body 11 side of the tubular part 10 to the axis X1 side of the tubular part 10.

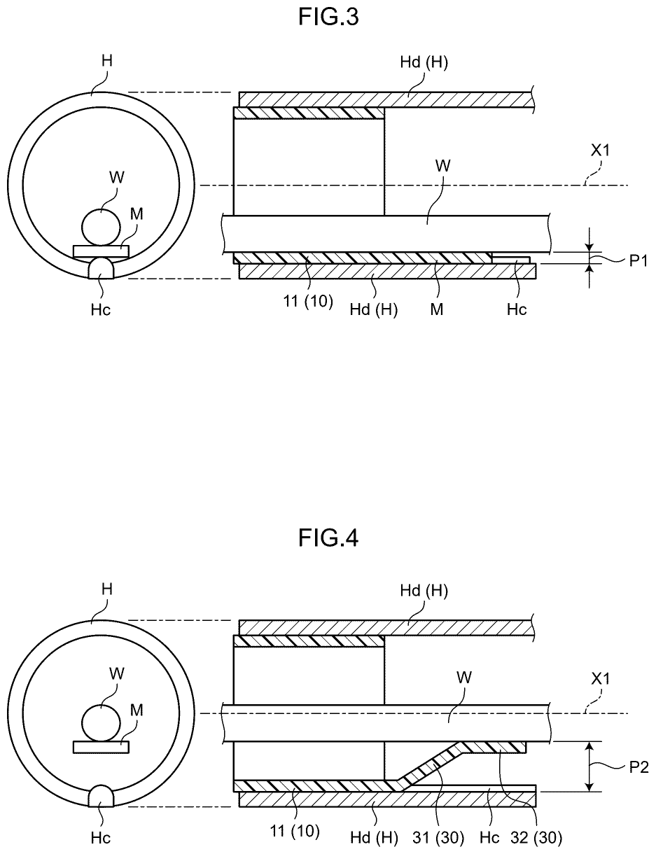

In this example, as illustrated in FIG. 3, a support plate M according to a comparative example is connected to the tubular part main body 11, without being offset to the axis X1 side of the tubular part 10, for example. Therefore, an interval P1 between the wiring material W held by the support plate M and a welded part Hc of the headrest stay H becomes relatively small. Hence, the wiring material W may interfere with the welded part Hc. In this example, the welded part Hc is a member obtained by welding the end parts of a bent sheet metal in the peripheral direction R, when the headrest stay H is formed by bending a sheet metal in a ring shape along the peripheral direction R. The welded part Hc is formed along the axial direction X, and a part of the welded part Hc protrudes to the inside of the headrest stay H.

In contrast, as illustrated in FIG. 4, the support plate 32 according to the present embodiment is offset from the tubular part main body 11 side to the axis X1 side. Hence, an interval P2 between the wiring material W and the welded part Hc in the radial direction Y is increased than the interval P1 in the comparative example. Consequently, the support plate 32 can support the wiring material W in a state where the wiring material W is separated from the welded part HC to the axis X1 side. Hence, it is possible to prevent the wiring material W held by the support plate 32 from interfering the welded part Hc.

In the protector 1 described above, the pipe member to which the protector 1 is fitted is the headrest stay H that connects the headrest pad to the seat back of a vehicle in a vertically movable manner. The covering part 20 covers the tip end Ha of the headrest stay H in the axial direction X, in a state where the tubular part 10 is inserted into the inside of the headrest stay H. In this manner, by applying the protector 1 to the headrest stay H, it is possible to properly route the wiring material W in the headrest stay H, while satisfying the regulations for interior fittings described above.

The wire harness WH includes the wiring material W having conductivity, the tape member T that fixes the wiring material W, and the protector 1. Hence, it is possible to properly route the wiring material W in the headrest stay H.

In the above description, an example in which the support part 30 includes the plate-shaped support plate 32 that supports the wiring material W has been described. However, it is not limited thereto, and for example, the support part 30 may include a rod-shaped rod member that supports the wiring material W.

An example in which the support plate 32 is offset from the tubular part main body 11 side to the axis X1 side has been described. However, it is not limited thereto, and the support plate 32 may also be provided on the tubular part main body 11 side without being offset.

An example in which the pipe member is the headrest stay H has been described. However, it is not limited thereto, and the pipe member may also be another tubular member.

A protector according to the present embodiment can prevent the tip end of a pipe member from being exposed by a covering part. Moreover, the protector can fix a wiring material to a support part, by wrapping a tape member around the support part and the wiring material, in a state where the support part is supporting the wiring material inserted inside. For example, compared to a conventional example in which the headrest side and the seat side are electrically coupled, by fitting the connector coupled to the wiring material routed in the headrest stay, to the counterpart connector provided in the seat back, the protector can prevent the number of components from increasing. As a result, a protector and a wire harness including the protector can properly route a wiring material in a pipe member.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A protector, comprising:
a tubular part formed around an axis in a tubular shape, locked to a pipe member formed in a tubular shape in a state where the tubular part is inserted into an inside of the pipe member, and into which a wiring material is inserted;
a covering part provided on one side of the tubular part in an axial direction along the axis, placed outside the pipe member, and that covers a tip end of the pipe member in the axial direction; and
a support part provided on another side of the tubular part in the axial direction, that extends to a side opposite to the covering part along the axial direction from the other side of the tubular part, and around which a tape member is wrapped with the wiring material in a state where the support part is supporting the wiring material.

2. The protector according to claim 1, wherein
the support part includes a plate-shaped support plate that supports the wiring material, and
the support plate is offset from a wall part side of the tubular part to the axis side of the tubular part.

3. The protector according to claim 2, wherein
the pipe member is formed by bending a sheet metal in a ring shape along a peripheral direction around the axis, and includes a welded part obtained by welding end parts of the bent sheet metal in the peripheral direction, and
the support plate supports the wiring material in a state where the wiring material is separated from the welded part to the axis side.

4. The protector according to claim 1, wherein
the pipe member is a headrest stay that connects a headrest pad to a seat back of a vehicle in a vertically movable manner, and
the covering part covers a tip end of the headrest stay in the axial direction, in a state where the tubular part is inserted into an inside of the headrest stay.

5. The protector according to claim 2, wherein
the pipe member is a headrest stay that connects a headrest pad to a seat back of a vehicle in a vertically movable manner, and
the covering part covers a tip end of the headrest stay in the axial direction, in a state where the tubular part is inserted into an inside of the headrest stay.

6. A wire harness, comprising:
a wiring material having conductivity;
a tape member that fixes the wiring material; and
a protector that includes
a tubular part formed around an axis in a tubular shape, locked to a pipe member formed in a tubular shape in a state where the tubular part is inserted into an inside of the pipe member, and into which a wiring material is inserted,
a covering part provided on one side of the tubular part in an axial direction along the axis, placed outside the pipe member, and that covers a tip end of the pipe member in the axial direction, and
a support part provided on another side of the tubular part in the axial direction, that extends to a side opposite to the covering part along the axial direction from the other side of the tubular part, and around which the tape member is wrapped with the wiring material in a state where the support part is supporting the wiring material.
